(19) United States
(12) Patent Application Publication
(10) Pub. No.: US 2012/0280949 A1
(43) Pub. Date: Nov. 8, 2012

(54) TOUCH PEN

(76) Inventor: Pei-Lin HUANG, New Taipei City (TW)

(21) Appl. No.: 13/462,560

(22) Filed: May 2, 2012

(30) Foreign Application Priority Data
May 6, 2011 (TW) 100208164

(51) Int. Cl. G06F 3/033

(52) U.S. Cl. 345/179

(57) ABSTRACT

A touch pen comprises a barrel, a laser module, a touch head and batteries: the barrel with a hollow interior which is separated into a barrel part and a necking nib part; the laser module which is disposed in the barrel and close to the nib part for generation of a laser beam as one pointer; the touch head featuring conductivity, covering the nib part and provided with a penetrating optical channel for a laser beam; the batteries held in the barrel part and supplying electricity necessary to the laser module; the touch pen is applicable to operation of a capacitive touch panel and regarded as one pointer projecting a laser spot.

The current application claims a foreign priority to the patent application of Taiwan No. 100208164 filed on May 6, 2011.

### BACKGROUND OF THE INVENTION

1. Field of the Invention

The present disclosure relates to a touch pen, especially a touch pen applicable to a capacitive touch panel and taken as a laser pointer.

2. Description of the Prior Art

The fast developed electronic industry has led to more and more constantly innovative 3C products, particularly touch user interfaces as a tendency and mainstream in the future.

Basically, a touch user interface is based on a graphic user interface with a touch panel and an operation system integrated. According to inductive theories, touch panels can be divided into resistive touch panels, capacitive touch panels, optical touch panels, electromagnetic touch panels and ultrasonic touch panels. As the first touch panels used in personal digital assistants and mobile phones, resistive touch panels work when they are strongly touched by a touch pen with a thin stiff nib which easily wears a resistive touch panel's surface away and fails in the multi-touch function.

Provided with capacitive touch panels and supporting the multi-touch function by integrating a smooth graphic user interface, Apple's mobile phones and tablet computers have triggered not only consumers' favorable responses but also capacitive touch panels applied to more and more 3C products. In general, a capacitive touch panel is directly operated by a user's fingers which are less skillful than a touch pen during hand input. Furthermore, a touch pen applicable to a conventional resistive touch panel cannot be used in operating a capacitive touch panel directly because of different inductive theories between a capacitive touch panel and a resistive touch panel.

### SUMMARY OF THE INVENTION

The present invention provides a touch pen which is applicable to a capacitive touch panel and taken as a pointer projecting a laser spot.

The present invention in an embodiment comprises:

A barrel with a hollow interior which is separated into a barrel part and a necking nib part;

A laser module which is disposed in the barrel and close to the nib part for generation of a laser beam as one pointer;

A touch head featuring conductivity, covering the nib part and provided with a penetrating optical channel for a laser beam; and

Batteries held in the barrel part and supplying electricity necessary to the laser module; the touch pen is applicable to operation of a capacitive touch panel and regarded as one pointer projecting a laser spot.

According to an embodiment of the present invention, the touch head is manufactured with conductive rubber, silicon rubber or other conductive materials as media to conduct current between the touch head and the capacitive touch panel.

According to an embodiment of the present invention, the touch head further comprises diversified touch heads, each of which has an optical channel with a distinct profile for generation of a special shaped laser spot and a preferable diameter between 0.1 mm and 5 mm.

The present invention provides a touch pen which is applicable to a capacitive touch panel and taken as a laser pointer projecting a laser spot.

Other effects and embodiments as regards the present invention with drawings presented are described hereinafter.

### BRIEF DESCRIPTIONS OF THE DRAWINGS

The objects, spirits, and advantages of the preferred embodiments of the present invention will be readily understood by the accompanying drawings and detailed descriptions, wherein:

FIG. 1 illustrates a structure of the present invention in an embodiment and is the sectional view of a touch pen.

FIG. 2 is the partial enlargement view for circle A in FIG. 1.

FIG. 3 is the schematic illustration to operate the present invention in an embodiment wherein a touch head's touch control surface contacts a capacitive touch panel and is slightly deformed.

FIG. 4 is the schematic illustration to operate the present invention in an embodiment wherein a laser beam is emitted from an optical channel.

FIG. 5 illustrates a touch head of the present invention in another embodiment wherein the profile indicates a touch head and a nib part which are integrated.

FIG. 6 illustrates a structure of the present invention in an embodiment and the equivalent circuit of a laser module.

FIG. 7 is the sectional view of the present invention in an embodiment and illustrates a laser module's circuitry.

FIG. 8 illustrates a touch head of the present invention in another embodiment wherein the profile indicates a touch head and a nib part, both of which are integrated.

FIG. 9 illustrates a touch head of the present invention in another embodiment wherein the profile indicates a touch head and a nib part, both of which are integrated.

### DETAILED DESCRIPTION OF THE INVENTION

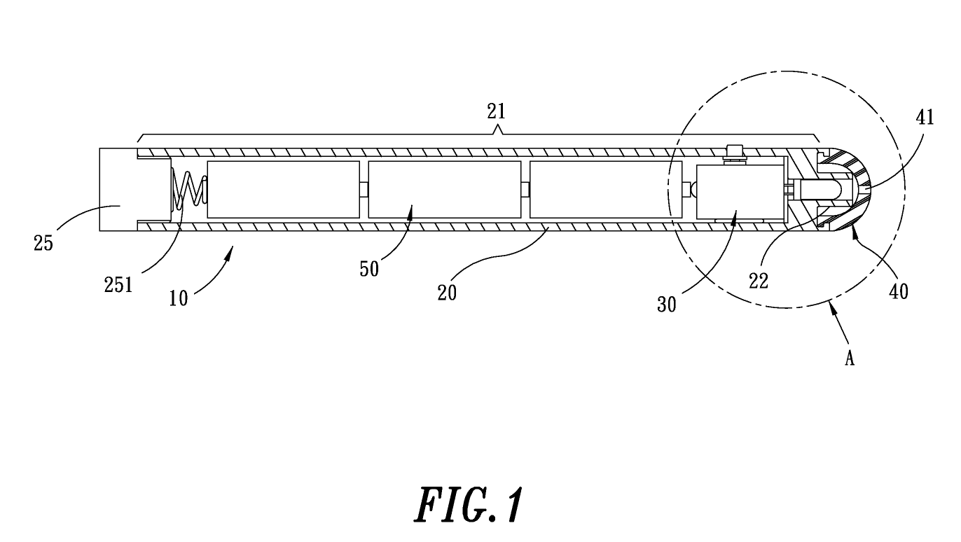

Referring to FIG. 1 which illustrates an embodiment of the present invention of a touch pen 10 comprising:

A barrel 20 with a hollow interior which is separated into (a) a barrel part 21 for accommodating batteries and (b) a necking nib part 22;

A laser module 30 disposed in the nib part 22 and generating a laser beam as one pointer;

A touch head 40 featuring conductivity, covering the nib part 22, and provided with a penetrating optical channel 41 whose diameter between 0.1 mm and 5 mm allows a laser beam to pass through; and

Batteries 50 which are held in the barrel part 21 and provide power necessary to the laser module 30.

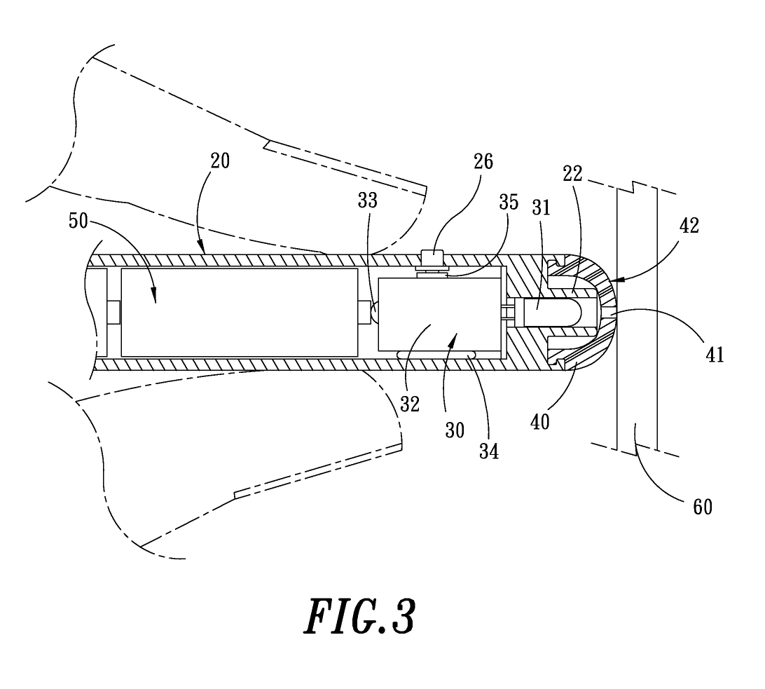

The touch head 40 is manufactured with conductive rubber, silicon rubber, or other conductive materials; the barrel 20 is manufactured with either a conductive material (e.g., aluminum alloy, metal tube, or alternative nonmetallic conductive material) or a nonconductive material (e.g., plastic tube). The barrel 20 manufactured with a conductive material has a conductive external surface which is contacted by a user's fingers in order to conduct current from the barrel 20 to the touch head 40 as well as from a user's fingers to a capacitive touch panel 60. Accordingly, a touch control function is realized when the present invention of the touch pen 10 held by a user contacts a capacitive touch panel 60 (FIG. 3), that is, the capacitive touch panel 60 is equivalently touched by a user's fingers.

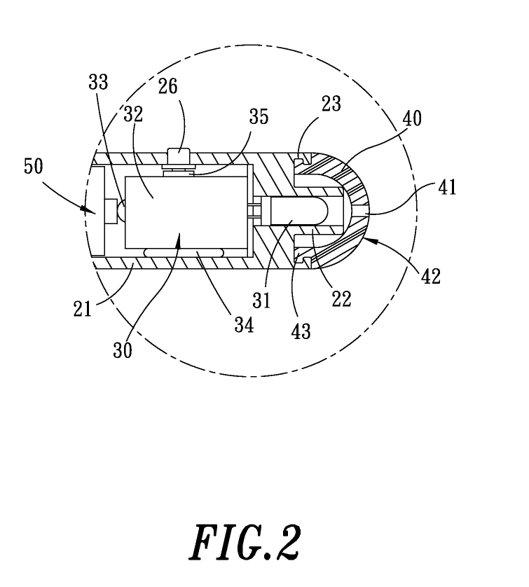

As shown in FIG. 2, the bowl-shaped touch head 40 comprises a touch control surface 42 which is used to contact the capacitive touch panel 60 and thus is slightly pressed and deformed (FIG. 3) for supply of stable touch and buffering effect; in an embodiment for a combination of the touch head 40 and the barrel 20 (FIG. 2), a circular groove 23 facing the axis of the barrel 20 is designed at an area that the barrel part 21 adjoins a necking nib part 22, and a corresponding circular fastening part 43 is disposed at the periphery of the touch head 40 and matches the groove 23 for the purpose of the touch head 40 covering the nib part 22.

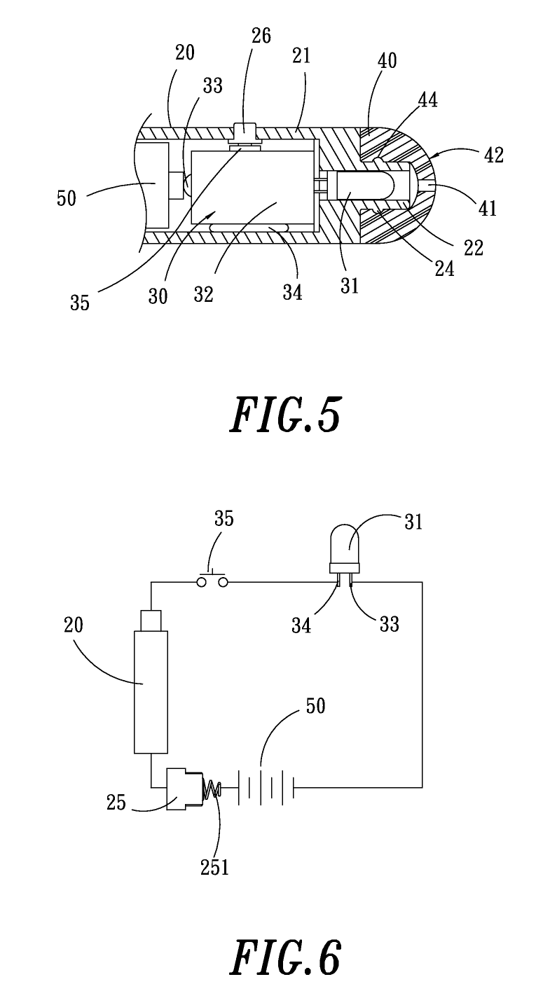

In another embodiment for a combination of the touch head 40 and the barrel 20 (FIG. 5), a circular convex rib 24 is disposed at an external surface of the nib part 22, and a corresponding circular groove 44 is designed at an internal surface of the touch head 40 and matches the convex rib 24 for the purpose of the touch head 40 covering the nib part 22. As examples of multiple feasible structures only rather than any limitation in a combination, the disclosed embodiments in the present invention for combinations of the touch head 40 and the barrel 20 can be modified and changed easily by any person skilled in the art.

The laser module 30 comprises a laser diode 31, a fixed part 32, a first electrode contact 33, a second electrode contact 34 and a switch element 35. A circuitry for electricity supplied to the laser module 30 from the batteries 50 is changeable in two types of embodiments because the barrel 20 based on used materials is either conductive or nonconductive. The feasible embodiments are shown as follows.

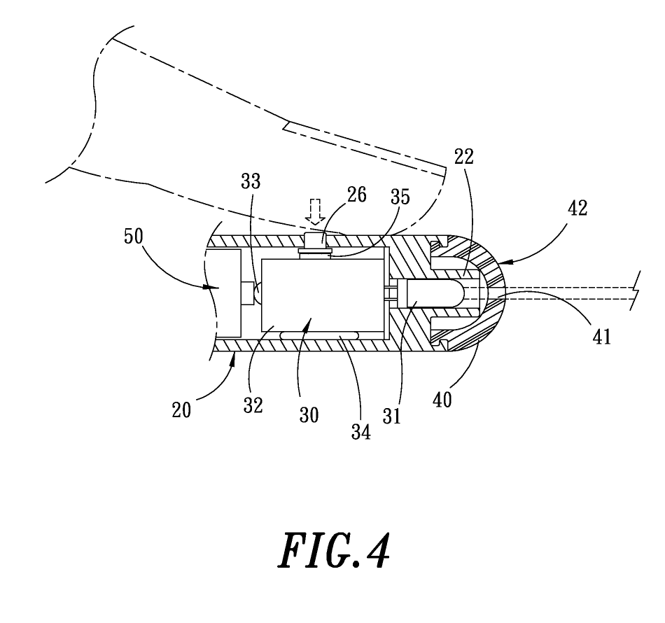

FIG. 1 and FIG. 2 illustrate one embodiment of the conductive barrel 20 which contacts the second electrode contact 34 and is covered by an end cap 25 at its rear-end opening wherein the end cap 25 is conductive, screwed onto the rear-end opening of the barrel 20 as a bolt, and connected to a resilient conducting component 251 (e.g., metal spring). The series-connected batteries 50 allow both ends to contact the first electrode contact 33 and the conducting component 251, respectively. As shown in FIG. 6 for an equivalent circuit, a circuitry is composed of the batteries 50, the conducting component 251, the end cap 25, the barrel 20, the first electrode contact 33 and the second electrode contact 34 when the switch element 35 is compressed by a push button 26 embedded in the barrel 20 (FIG. 4), and thus a laser beam is emitted by a laser diode 31 and projected through an optical channel 41 so that the touch pen 10 is taken as a pointer projecting a laser spot.

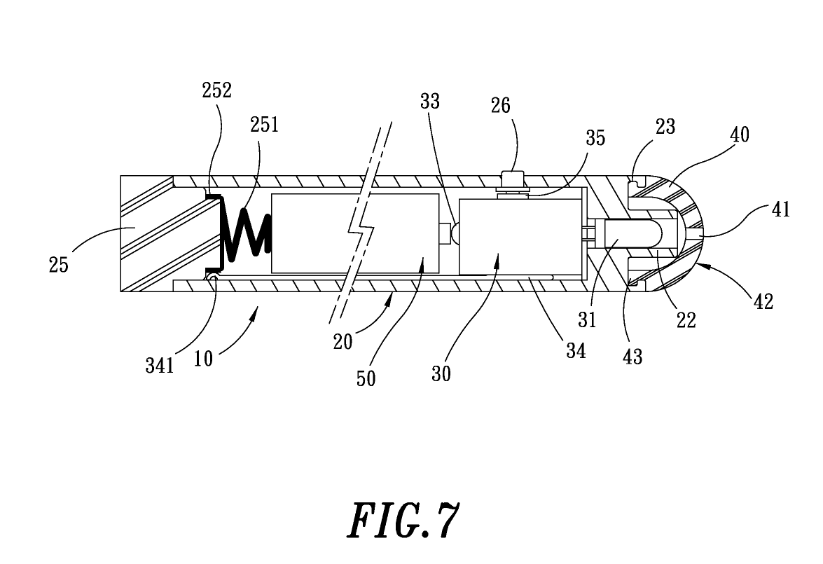

In the embodiment as shown in FIG. 7, the barrel 20 is nonconductive; the second electrode contact 34 has an extended contact 341 which is disposed inside the barrel 20 until the rear end of the barrel 20; an end cap 25 is installed at the rear-end opening of the barrel 20 and links a resilient conducting component 251 (e.g., metal spring) as well as a conducting ring 252, both of which are electrically connected each other. When the end cap 25 is assembled to the rear end of the barrel 20, the conducting ring 252 contacts the extended contact 341 and allows two ends of the batteries 50 to touch the first electrode contact 33 and the conducting component 251, respectively. As the switch element 35 is compressed by the push button 26 embedded in the barrel 20 (FIG. 4), a circuitry is developed by the batteries 50, the conducting component 251, the conducting ring 252, the extended contact 341, the first electrode contact 33 and the second electrode contact 34, and thus a laser beam is emitted by the laser diode 31 and projected through the optical channel 41 so that the touch pen 10 is taken as a pointer projecting a laser spot.

In an embodiment, the present invention further comprises diversified touch heads 40, each of which has the optical channel 41 with its distinct profile and creates a laser beam spot with an exclusive shape.

Additionally, FIG. 8 illustrates a structure of the present invention in one embodiment which is different from that of FIG. 1: the laser module 30 is disposed in the barrel part 21 and close to the nib part 22; the laser diode 31 is fixed outside and opposite to the necking nib part 22, which corresponds to the optical channel on the touch head 40, and generates a light source passing through the necking nib part 22 and guided to the optical channel 41 on the touch head 40 for output. Other components are identical to those of FIG. 1 and not further described herein.

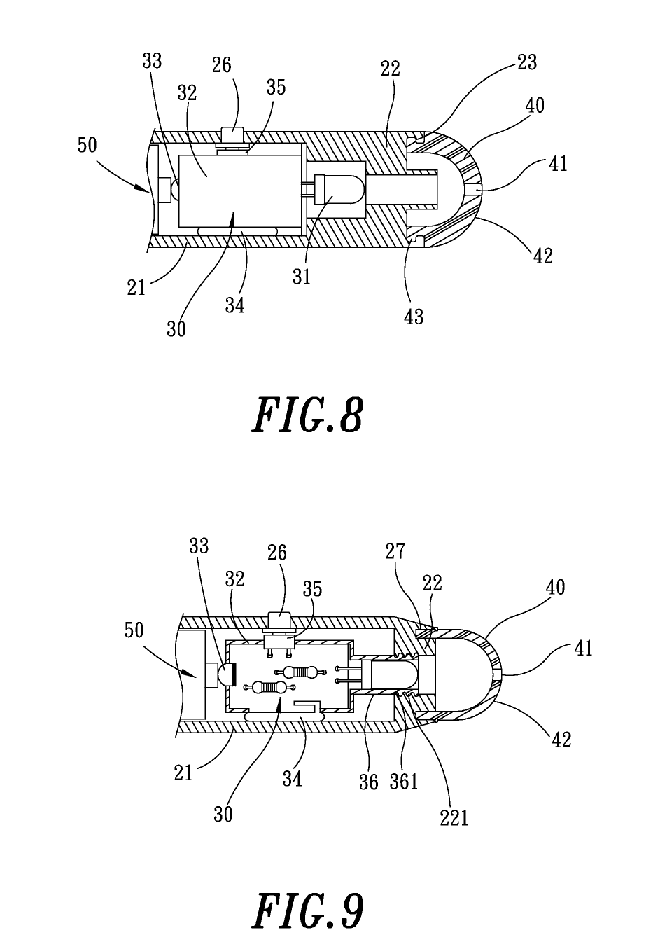

Referring to FIG. 9 which illustrates a structure of the present invention in an embodiment which is different from that of FIG. 1: the laser diode 31 of the laser module 30 is encased in a casing 36 on which there are external threads 361; the necking nib part 22 which is provided with internal threads 221 for engagement of the external threads 361 allows the casing 36 with the laser diode 31 integrated to be fixed in the necking nib part 22 and opposite to the optical channel 41 of the touch head 40 as well as guides a light source induced by the laser diode 31 to the optical channel 41 of the touch head 40 and finally outside the optical channel 41; a clip slot 27 is disposed outside the nib part 22 in order to insert the edge of the touch head 40 into the clip slot 27, fasten the top end of the clip slot 27, and fix the touch head 40 into the clip slot 27 of the nib part 22. Other components are identical to those of FIG. 1 and not further described herein.

Furthermore, the nib part and the barrel abovementioned can be alternatively assembled or unified during manufacture.

Notwithstanding the foregoing, the embodiments disclosed for the present invention do not limit the present invention and any person skilled in the art may change or modify embodiments without departing from the spirit and scope of the present invention. Therefore, the scope to be protected under the patent should refer to claims of the patent specifications.

What is claimed is:

1. A touch pen, comprising:
A barrel with a hollow interior which is separated into a barrel part and a necking nib part;
A laser module which is disposed in said barrel and close to said nib part for generation of a laser beam as one pointer;
A touch head featuring conductivity, covering said nib part and provided with a penetrating optical channel for a laser beam; and
Batteries held in said barrel part and supplying electricity necessary to said laser module.

2. The touch pen according to claim 1 wherein a circular groove facing said barrel's axis is disposed at an area that said barrel part adjoins the necking nib part and a corresponding circular fastening part is designed at said touch head's periphery and matches said groove.

3. The touch pen according to claim 1 wherein said nib part at its outside surface is provided with a circular convex rib which matches a corresponding circular groove disposed at said touch head's internal surface.

4. The touch pen according to claim 1 wherein said barrel is conductive; said laser module comprises a laser diode, a fixed part, a first electrode contact, a second electrode contact and a switch element; said second electrode contact touches said conductive barrel; said barrel at its rear-end opening comprises an end cap which is conductive and links a resilient conducting component; said batteries have their both ends to contact said first electrode contact and said conducting component, respectively.

5. The touch pen according to claim 1 wherein said barrel is nonconductive; said laser module comprises a laser diode, a fixed part, a first electrode contact, a second electrode contact and a switch element; said second electrode contact comprises an extended contact which reaches said barrel's rear end along said barrel's interior; said barrel at its rear-end opening is provided with an end cap which comprises a resilient conducting component and a conducting ring which are electrically connected; said conducting ring touches said extended contact as said end cap is mounted on said barrel's rear end.

6. The touch pen according to claim 1 wherein said touch head is manufactured with either conductive rubber or silicon rubber.

7. The touch pen according to claim 1 wherein said touch head is a bowl-shaped component which comprises a touch control surface used to contact a capacitive touch panel and is slightly deformed as said capacitive touch panel is pressed by said touch control surface.

8. The touch pen according to claim 1 wherein said touch pen comprises diversified touch heads, each of which has said optical channel with its distinct profile.

9. The touch pen according to claim 1 wherein said touch head has an optical channel with a preferable diameter between 0.1 mm and 5 mm.

10. The touch pen according to claim 1 wherein said laser module's laser diode can be encased in a casing which is fixed in said necking nib part.
